(19) United States
(12) Patent Application Publication
(10) Pub. No.: US 2023/0050425 A1
(43) Pub. Date: Feb. 16, 2023

(54) MAGNET-ASSISTED WIRELESS CHARGING AND DEVICES THEREFOR

(71) Applicant: Leviton Manufacturing Co., Inc., Melville, NY (US)

(72) Inventors: Kyle COHEN, Wantagh, NY (US); Melissa Ann CINELLI, Commack, NY (US); William RANDALL, Port Washington, NY (US)

(73) Assignee: Leviton Manufacturing Co., Inc., Melville, NY (US)

(21) Appl. No.: 17/758,890

(22) PCT Filed: Nov. 13, 2020
(86) PCT No.: PCT/US2020/060326

§ 371 Date: Jul. 15, 2022

Related U.S. Application Data
(60) Provisional application No. 62/965,188, filed on Jan. 24, 2020.

(51) Int. Cl. H02J 50/00; H02J 50/10; H02J 50/40; H02J 50/90; H01R 25/00; H01R 27/02; H01R 13/516; H02G 3/08; H01F 7/20

(52) U.S. Cl. CPC H02J 50/005; H01F 7/20; H01R 13/516; H01R 25/006; H01R 27/02; H02G 3/081; H02J 50/10; H02J 50/90; H02J 50/402

(57) ABSTRACT

A wiring device includes a line input terminal configured to couple to a source of alternating current (AC) power and a charging circuit having an induction coil to propagate a magnetic charging field to emanate from the wiring device. The wiring device can be provided individually or in a kit with a wall plate configured for covering the wiring device. Magnet(s) can be provided proximate a front face of a housing of the wiring device, and/or included in/on a wall plate, to magnetically attract an electronic device when the electronic device is positioned proximate the front face. Such wall plates can be provided individually without a wiring device. Additionally or alternatively, a wall plate with or without magnets can include a shelf protruding from a bottom portion thereof, the shelf configured to support an electronic device in position of a front face of a housing of a wiring device.

### BACKGROUND

Residential and commercial buildings provide wall outlets for powering electronic devices such as lights, appliances, computers, and mobile devices. Due to the proliferation of rechargeable consumer electronic devices including cell phones, laptops, tablets, personal digital assistants (PDA’s), and other types of mobile devices, there is a desire for convenient charging of such devices. Mobile devices have internal batteries that are commonly recharged using an alternating current (AC) adapter that plugs into a wall outlet. The AC adapter converts line voltage to a lower output voltage that is fed through a cable to a connector port on the mobile device. Such plug and socket connections to charge mobile devices have evolved over time and now routinely leverage common or standardized connector types, such as those of the Universal Serial Bus (USB) specification.

Charging voltages for smartphones and other small mobile devices are typically 5 volts (V) or below, though some newer specifications, such as USB Power Delivery (USB PD), reaches up to 20 volts. In an effort to accommodate the proliferation of mobile devices and the desire for convenient charging, electrical outlet manufacturers have incorporated USB connectors into wall box wiring device offerings, such as single-gang wall outlet electrical wiring devices that also include standard 120 V receptacles, or standalone USB-only electrical wiring devices.

### SUMMARY

Particularly with smartphones and other relatively small form-factor mobile devices, there is a desire to replace traditional wired charging with wireless power transfer capabilities. An example type of wireless power transfer is inductive charging. Inductive charging leverages electromagnetic induction to provide electricity to a mobile device. This in turn charges the battery of the mobile device. Many examples exist of wireless chargers that are powered through a USB port, however there are no available solutions offering wireless charging technology directly integrated into a wall box powered device. These and other aspects are provided herein.

Shortcomings of the prior art are overcome and additional advantages are provided through the provision of a wiring device that includes a housing that has a front face; a strap, the strap being coupled to the housing and being configured to couple the wiring device to an electrical box; a line input terminal configured to couple to a source of alternating current (AC) power; a charging circuit at least partially disposed within the housing, the charging circuit coupled to the line input terminal, the charging circuit comprising an induction coil configured to propagate a magnetic charging field to emanate from the wiring device; and a magnet disposed proximate the front face of the housing of the wiring device and configured to magnetically attract an electronic device when the electronic device is proximate the front face of the housing of the wiring device.

The magnet can include an electromagnet coupled to the line input terminal and powered thereby. In some embodiments, a magnet is disposed in a center of the induction coil. The magnet can be configured to magnetically attract a stick-on magnet or case of the electronic device when the electronic device is proximate the front face of the housing of the wiring device.

The wiring device can include a plurality of magnets disposed proximate the front face of the housing of the wiring device. The plurality of magnets can be arrayed across at least a portion of the front face of the housing of the wiring device. Additionally or alternatively, the plurality of magnets can be disposed at least partially peripheral to the induction coil. In some embodiments, the plurality of magnets can include four magnets.

The charging circuit can include a plurality of induction coils configured to propagate magnetic charging fields.

The front face of the housing of the wiring device can be exposed to provide access to the front face when the wiring device is mounted in the electrical box. The wiring device can further include a Universal Serial Bus (USB) connector and a USB charging circuit coupled to the line input terminal and the USB connector. Additionally or alternatively, the wiring device can further include a line voltage receptacle configured to selectively couple the source of AC power to an electrical plug.

The housing may be a multi-gang housing, where the multi-gang housing further includes a first region and a second region, and where the induction coil is disposed at least partially within the first region of the multi-gang housing and the line voltage receptacle is disposed at least partially within the second region of the multi-gang housing.

Further, a kit is provided that includes a wiring device and a wall plate configured to cover at least a portion of the wiring device. The wiring device includes a housing having a front face; a strap, the strap being coupled to the housing and being configured to couple the wiring device to an electrical box; a line input terminal configured to couple to a source of alternating current (AC) power; and a charging circuit at least partially disposed within the housing, the charging circuit coupled to the line input terminal, the charging circuit comprising an induction coil configured to propagate a magnetic charging field to emanate from the wiring device. The wall plate is configured to cover at least a portion of the wiring device. The wall plate includes a magnet configured to magnetically attract an electronic device when the electronic device is proximate the front face of the housing of the wiring device.

In some embodiments the wall plate includes a plurality of magnets. The magnets can be arrayed across a top portion and a bottom portion of the wall plate. The magnets could be elongated magnets each disposed proximate a respective side of a plurality of sides of the wall plate. The wall plate could include four sides, and a respective one or more magnets of the plurality of magnets can be disposed along a respective side of the four sides of the wall plate. A magnet of the wall plate can be an elongated magnet disposed proximate one side of the wall plate.

The wiring device can also include magnet(s) disposed proximate the front face of the housing of the wiring device.

The wall plate can further include a shelf having a top surface, where the shelf protrudes from a portion of the wall plate or a portion of the front face of the housing of the wiring device.

A charging region can be defined by the magnetic charging field emanating from the wiring device, where the shelf can be configured to support the electronic device at least partially within the charging region defined by the magnetic charging field. Magnet(s) of the wall plate can be disposed and configured to attract a top portion of the electronic device toward the wiring device as the shelf supports the electronic device. The shelf can additionally or alternatively include a lip protruding from the top surface of the shelf.

In some embodiments, the wall plate is a ‘blank’, having a surface configured to cover the front face of the housing of the wiring device, where the magnetic charging field is configured to emanate from the wiring device through the surface of the wall plate.

Additionally or alternatively, the wall plate can include an aperture through which the front face of the housing of the wiring device is accessible, where the wall plate is configured to at least partially surround the front face of the housing of the wiring device when the wiring device is mounted in the electrical box.

Further, a wall plate is provided that is configured for at least partially covering a wiring device. The wall plate includes a top portion and a bottom portion; a shelf protruding from the bottom portion of the wall plate and configured to support an electronic device in position of a front face of a housing of the wiring device; and a magnet configured to magnetically attract the electronic device when the electronic device is proximate the front face of the housing of the wiring device.

The magnet can include an elongated magnet disposed proximate one side of the wall plate. Additionally or alternatively, the magnet can be disposed and configured to attract a top portion of the electronic device toward the wiring device as the shelf supports the electronic device.

In some embodiments, the wall plate includes a plurality of magnets arrayed across the top portion of the wall plate. The wall plate could include a plurality of elongated magnets each disposed proximate a respective side of a plurality of sides of the wall plate.

Additionally or alternatively, the shelf can include a top surface and a lip protruding from the top surface of the shelf.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of an electrical device assembly in accordance with aspects described herein;

FIGS. 2A-2F depict example embodiments of a wiring device incorporating an electromagnetic charging coil, in accordance with aspects described herein;

FIGS. 3A-3F depict example embodiments of a wiring device incorporating magnet(s) for magnetically attracting objects to a front face of the wiring device, in accordance with aspects described herein;

FIGS. 4A-4F depict example embodiments of a wall plate that incorporates magnet(s) for magnetically attracting objects, in accordance with aspects described herein;

FIGS. 5A-5J depict example embodiments of configurations for front faces of wiring devices, in accordance with aspects described herein;

FIGS. 6A-6C depict example embodiments of wiring devices with multi-gang housings, configured for coupling to multi-gang electrical wall boxes, in accordance with aspects described herein;

FIGS. 7A-7C depict example embodiments of wall plates that include a shelf, in accordance with aspects described herein;

FIGS. 8A-8D depict additional example embodiments of wall plates that include a shelf, in accordance with aspects described herein; and

FIGS. 9 and 10 depict example embodiments of an electronic device in operative position via magnetic attraction for wireless charging using a wiring device, in accordance with aspects described herein.

### DETAILED DESCRIPTION

Described herein are various aspects related to wall box wiring devices, such as electrical wiring devices. In some embodiments, wireless charging technology is incorporated into a wiring device. Additionally or alternatively, magnet(s) and/or electromagnets may be used to attract and position a mobile device or other electronic device for wireless charging. Various configurations for inductive coil(s), magnets, and USB connectors incorporated into wiring devices, and configurations for complementary wall plates for covering wiring devices, are also provided.

In particular embodiments, a wiring device incorporates wireless charging capabilities and one or more magnets and/or electromagnets. The magnet(s) can be configured and used to magnetically attract and hold an electronic device (such as a mobile phone, as an example) in place and position of a charging region of a wiring device to facilitate wirelessly charging the electronic device. The magnet(s) can magnetically engage with a housing and/or internal component(s) of the electronic device and/or a case or sleeve into which the electronic device is placed, as examples. In other embodiments, a sticker or other material can be placed on the electronic device for magnetically engaging with the magnet(s) to hold the device in place. Various configurations are possible for a wall box wiring device, including those with single-gang and multi-gang configurations, those with or without USB connectors/ports (USB-A, USB-C as examples), and those with or without electrical receptacles, such as standard line voltage (e.g. 120 V) three-prong outlets, as examples.

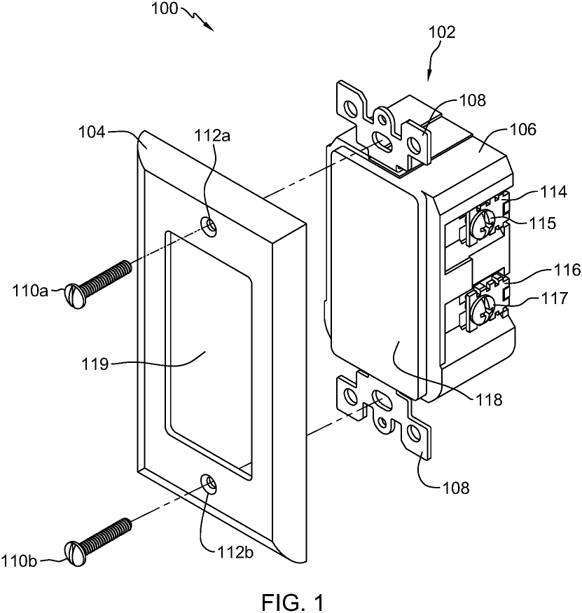

FIG. 1 depicts one embodiment of an electrical device assembly in accordance with aspects described herein. The assembly 100 includes a wiring device 102, in this example an electrical wiring device, and wall plate 104. Wiring device 102 is configured as a single-gang wall box device, configured to be positioned within a wall box (not pictured) installed in a building wall and electrically connected to in-wall electrical wiring. The wiring device 102 includes housing 106 and mounting strap 108 coupled to housing 106. The mounting strap is typically configured and used to couple the wiring device 102 to the wall box (also referred to as an electrical box) using mounting screws and retain the device 102 in position within the wall box. Wall plates are typically plastic or metal pieces that are detachable from the electronic wiring device. Here, screws 110a, 110b screw into strap 108 through screw holes 112a, 112b in wall plate 104 to retain wall plate 104 in position to cover the wall box and portions of the wiring device 102 for safety and aesthetic reasons.

Wiring device 102 includes a first terminal 114 (a “line” or “phase” input terminal) and a second terminal 116 (a “neutral” terminal) configured for electrically coupling to a source of power. As a specific example, the source is a standard 120 V 60 Hz alternating current (AC) line/phase input for powering the device 102. Each terminal 114, 116 includes a terminal screw (115 and 117) for securing electrical wiring to the device 102. Though not pictured, a ground terminal for connection to ground is also included in device 102.

Wiring device 102 can incorporate one or more power supplies capable of converting line power, for instance 120 V line power, to a relatively low-voltage power used in USB-A, USB-C and USB-C PD (“Power Delivery”) applications. Such power supplies are known and exist in current USB device portfolios.

In addition, as depicted and described herein with reference to other Figures, wiring device 102 includes circuitry for wireless charging. Example such circuity can comport with one or more wireless charging specifications/standards, an example of which is the Qi open interface standard developed by the Wireless Power Consortium (of which QI is a trademark). Wireless charging circuity is documented in the Qi wireless charging standard to provide power transfer via inductance charging to a target device. An inductive coil as documented in the Qi wireless charging standard functions as a means to transmit power. In aspects described herein, one or more inductive coils and related wireless charging circuitry can be incorporated into, for instance at least partially disposed within housing 106 of, a wiring device for transferring power from the wiring device to a target device, such as a smartphone or other electronic device. Wiring device 102 therefore includes a charging circuit at least partially disposed within housing 106, the charging circuit coupled to the line input terminal 114. The charging circuit includes one (or more) induction coil(s) configured to propagate magnetic charging field(s) to emanate from the wiring device.

The housing 106 of device 102 includes a front face 118. In examples, a magnetic charging field emanates through front face 118 of the housing 106. In this embodiment, front face 118 is generally rectangular but can take any suitable shape. The depicted rectangular shape in FIG. 1 is sometimes referred to as “decorator style” in the electrical industry. Wall plate 104 includes an aperture (or ‘cutout’) 119 through which front face 118 of housing 106 of wiring device 102 is accessible. A portion of housing 106, including the front face, can be configured to at least partially extend through the aperture. The wall plate 104 is configured such that it at least partially surrounds the front face of the housing of wiring device 102 when wiring device 102 is mounted in the wall/electrical box and wall plate 104 is in place. In this manner, front face 118 is exposed and user-accessible after the device 102 is fastened to the wall box and the wall plate installed. This enables access to connectors/receptacles and other components of front face 118. Additionally, a charging field emanates from device 102 through front face 118 to define a charging region in front of front face 118. Wireless charging may therefore be provided by positioning a compatible device with wireless charging capabilities in front of front face 118.

In some examples, magnet(s) and/or electromagnet(s) are incorporated into the mechanical design of the wiring device. The magnets can be selected and configured to be strong enough to hold a target electronic device in place. That is, the magnets can be selected and configured so that they magnetically attract the electronic device and hold the electronic device in the charging region to facilitate wireless charging thereof. Various examples of magnet arrangements are depicted and described herein. In some examples, magnet(s) are placed in an array and situated such that they do not interfere with included inductive coil(s) incorporated within the wiring device. If electromagnets are used, appropriate circuitry can be included within the wiring device to control the power to the electromagnets. Some electronic devices with wireless charging capabilities incorporate material that enables the electronic device to natively magnetically engage with external magnets. In other examples, a single use or reusable sticker/sticker magnet is adhered to the electronic device and engage with the magnet(s) and help hold the target device in the charging region.

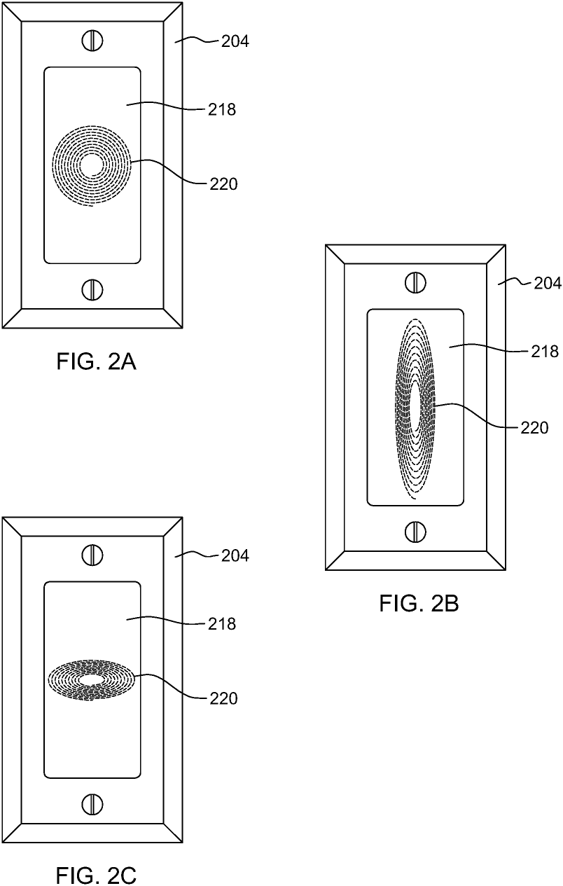

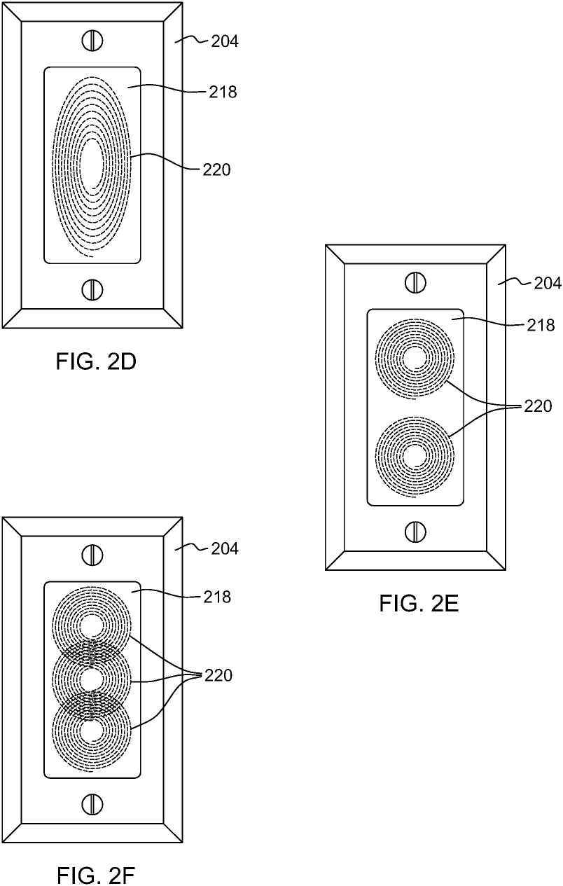

FIGS. 2A-2F depict example embodiments of a wiring device incorporating an electromagnetic charging coil, in accordance with aspects described herein. FIGS. 2A-2F present front views of a wiring device, such as that shown in FIG. 1, with a wall plate 204 in position to partially cover the wiring device, of which only the front face 218 is shown in each FIGS. 2A-2F. In these examples, the front face 118 of the housing of the wiring device is exposed to provide access to the front face 218 when the wiring device is mounted in the electrical box and the wall plate 204 is installed.

Various wireless charging inductive (electromagnetic) coil configuration examples are shown. Specifically, inductive coils 220 of varying size and orientation are depicted across FIGS. 2A-2F. An inductive coil 220 can be sized and oriented in any way desired. Considerations for size, orientation, and number of the coils include, but are not limited to, the magnitude of power transfer capability desired and the available room for coil(s) given the room needed for other devices, such as USB and/or other receptacles, in the wiring device and exposed via the front face of the device. As depicted in FIGS. 2E and 2F, the wiring device can incorporate two or more such coils 220. Thus, the charging circuit of the wiring device can include a plurality of induction coils where each induction coil is configured to propagate a magnetic charging field. Providing multiple coils can help ensure that the charging coil of the electronic device to be charged receives a strong charging signal.

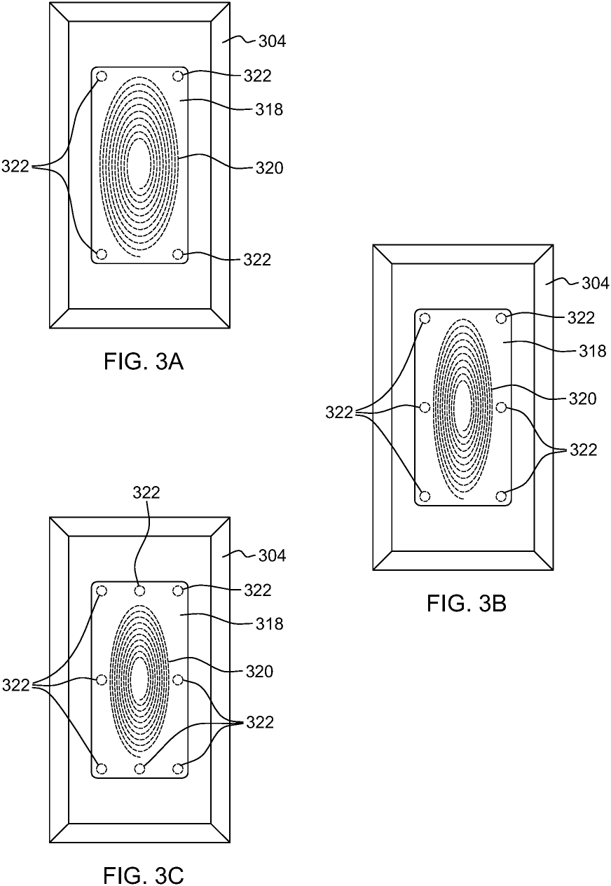

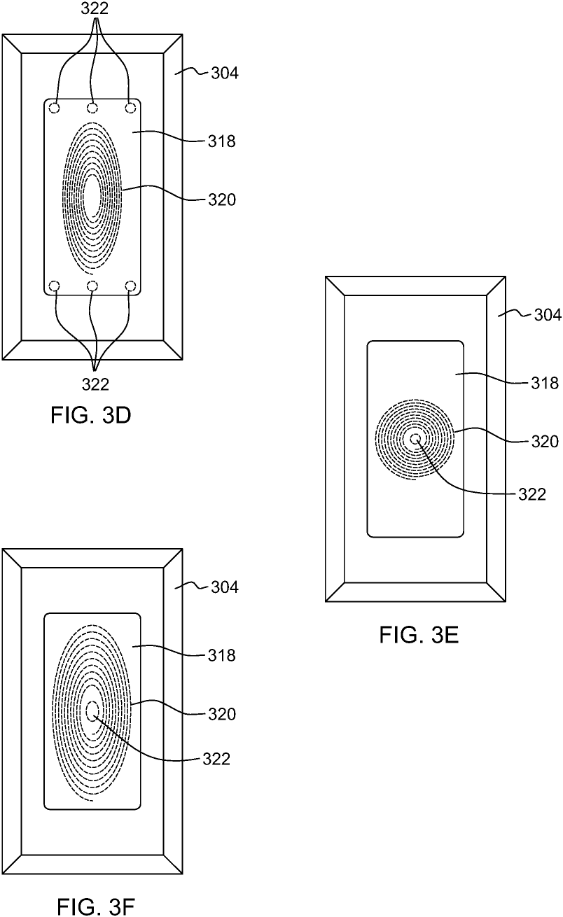

FIGS. 3A-3F depict example embodiments of a wiring device incorporating magnet(s) for magnetically attracting objects to a front face of the wiring device, in accordance with aspects described herein. Example wiring devices include one (or more) magnet(s) disposed proximate the front face, for instance at, in, or behind the front face of the wiring device’s housing. The magnet(s) can be selected and configured to magnetically attract an electronic device when the electronic device is proximate, i.e. next to, the front face. The magnets can engage with the electronic device, a housing, case, or stick-on magnet thereof, in order to attract the device, housing, case, or stick-on magnet when the electronic device is proximate the front face, and thus help hold the device in place.

Referring to FIGS. 3A-3F, each figure shows a wall plate 304, front face 318 of a housing of a wiring device, an example induction coil 320 positioned behind the front face 318 enclosed in the housing of the wiring device, and one or more magnets 322. The magnets are disposed proximate the front face 318 in these examples, for instance in or behind the surface of the front face 318. Magnet(s) 322 can include electromagnet(s) coupled to the line input terminal and powered thereby.

As shown in FIGS. 3A-3D, the wiring device includes a plurality of magnets disposed proximate front face 318. The plurality of magnets can total any number, for instance two, three, four, or more. In general, the selection and configuration of the magnets, including the number of magnets used, size, placement, power, and electronic signal (if using electromagnets), can be based on the power and position of magnetic attraction desired for target applications. For instance, selection of the foregoing parameters can be based on what will be sufficient to retain the types of devices to be charged. Additionally, governmental or other compliance standards, such as those of the Federal Communication Commission, may apply and can be taken into consideration. Electromagnetic radiation emission may also be a factor, in addition to consideration of potential issues or interference with the charging coil(s) and placement thereof.

The magnets can be arrayed across at least a portion of the front face 318 of the wiring device, as shown in FIGS. 3A-3D. Additionally or alternatively, the magnets can be disposed partially or fully surrounding, and/or peripheral to, the included induction coil(s) 320, for instance as shown in FIGS. 3A-3C.

In FIGS. 3E and 3F, the magnet 322 is disposed in a center of the induction coil 320. Magnet 322 of FIG. 3E is sized smaller than magnet 322 of FIG. 3F. Though FIGS. 3E and 3F show only a single magnet in the center of coil 322, multiple magnets may be disposed in the center thereof. Additionally or alternatively, additional magnet(s) can be disposed outside of the coil 320 in positions such as shown in FIGS. 3A-3D. In a particular example, additional magnets are positioned above and below the inductive coil(s) 320, i.e. at or near a top of the front face and bottom of the front face.

Where magnets are incorporated into or with the wiring device, such as in the housing of the wiring device, the wiring device can be used with any desired wall plate. In some embodiments, magnet(s) are instead, or additionally, incorporated into a wall plate. The wall plate may be used in conjunction with wiring devices described herein, such as those that include wireless charging capabilities. In embodiments where the wiring device does not include magnets as described with reference to FIGS. 3A-3F, a wall plate as described herein which incorporates magnet(s) can be sold or provided together with the wiring device as a kit.

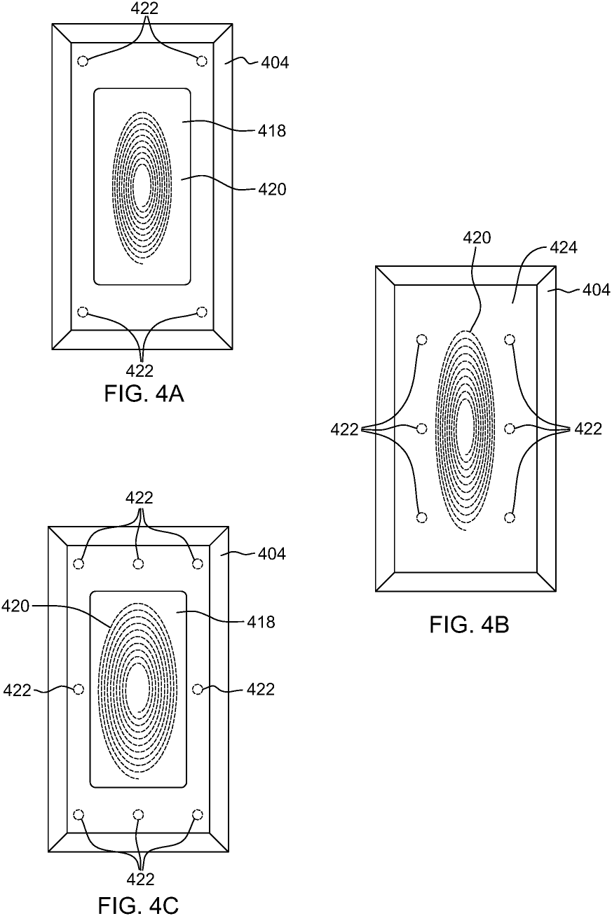

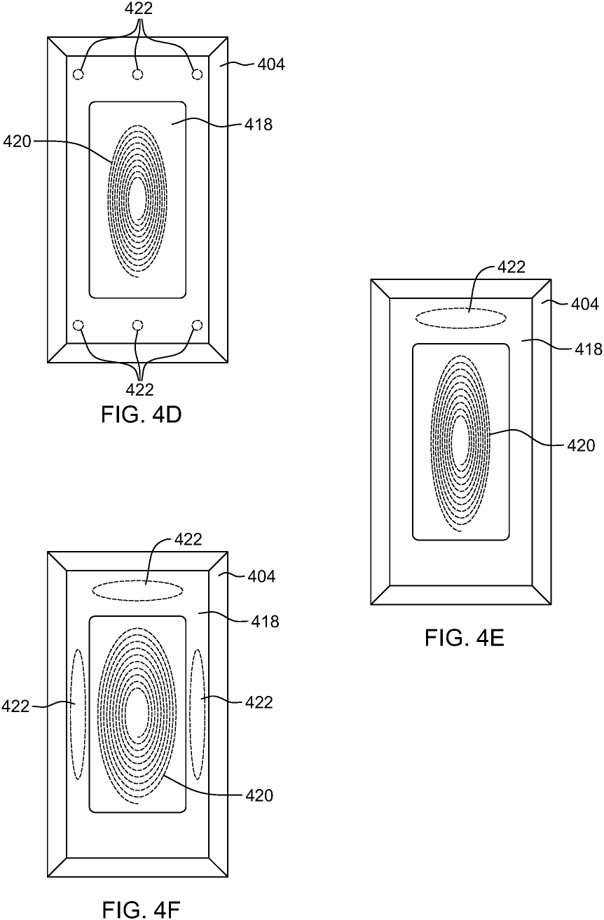

FIGS. 4A-4F depict example embodiments of a wall plate that incorporates magnet(s) for magnetically attracting objects, in accordance with aspects described herein. Various magnet designs are possible. Different designs can result in different magnetic forces, and thus provide a tailored magnetic engagement between different target devices (e.g. smartphones) and the charging device (i.e. the wiring device). In the examples of FIGS. 4A-4F, the wall plate 404 is configured for at least partially covering a wiring device. The wall plate includes one or more magnet(s) configured to magnetically attract an electronic device when the electronic device is proximate the front face of the wiring device housing. Depicted in each of FIGS. 4A-4F are a wall plate 404, one or more magnets 422, and a wireless charging induction coil 420 of a corresponding wiring device. With the exception of FIG. 4B, the front face 418 of the wiring device is exposed through the aperture in each wall plate 404 to render the front face accessible.

The selection and configuration (arrangement, size, number, etc.) of the magnets 422 can vary as desired. FIGS. 4A-4F depict just some examples. An example wall plate 404 includes a plurality of magnets arrayed across a top portion and a bottom portion of the wall plate (see, e.g., FIGS. 4A, 4C and 4D). As shown in FIG. 4C, the wall plate 404 includes a plurality of magnets and four sides, and a respective one or more magnets of the plurality of magnets is disposed along a respective side of the four sides of the wall plate. As shown in FIGS. 4E and 4F, elongated magnet(s) are shown proximate one or more sides of the wall plate 404.

FIG. 4B depicts a blank wall plate, i.e. without an aperture, having magnets positioned therein. Wall plate 404 of FIG. 4B includes a front surface 424 that wholly covers the wiring device and front face thereof, with no aperture to expose the underlying wiring device and front face thereof accessible. Nevertheless, the magnetic charging field of the wiring device may be configured to emanate from the wiring device through the surface 424 of wall plate 404.

Various embodiments of wall plates depicted in FIGS. 4A-4F and in other Figures presented and described herein lack wall plate mounting screws. These wall plates are screwless ‘snap-on mount’ type wall plates. A screwless wall plate typically has a subplate that screws to the wiring device and a ‘cosmetic’ plate that snaps into/onto the subplate. Other embodiments may be of the screw-mount/screwed type as shown in FIG. 1. It is understood that the configuration of magnet(s) within the wall plate may be varied depending on the wall plate type.

Wiring devices in accordance with aspects described herein can incorporate USB-type connectors for charging and/or standard line voltage electrical receptacles, such as 120 V two or three-prong receptacles. In some examples, a wireless charging circuit and, optionally, magnet(s) are incorporated into existing receptacle devices, for instance those including 120 V receptacles and/or USB charging connectors. Thus, wiring devices in accordance with aspects described herein can further include a USB connector and a USB charging circuit coupled to the line input terminal and the USB connector.

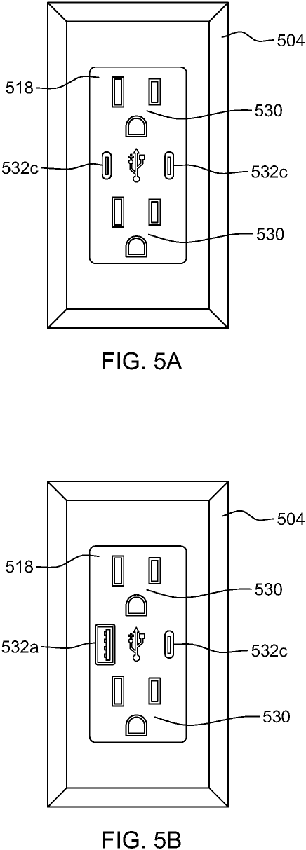

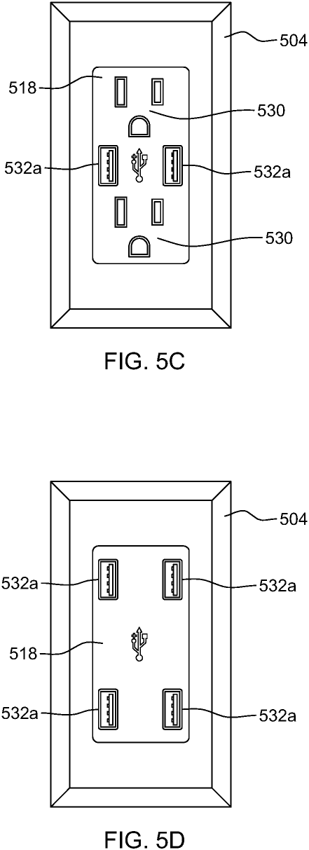

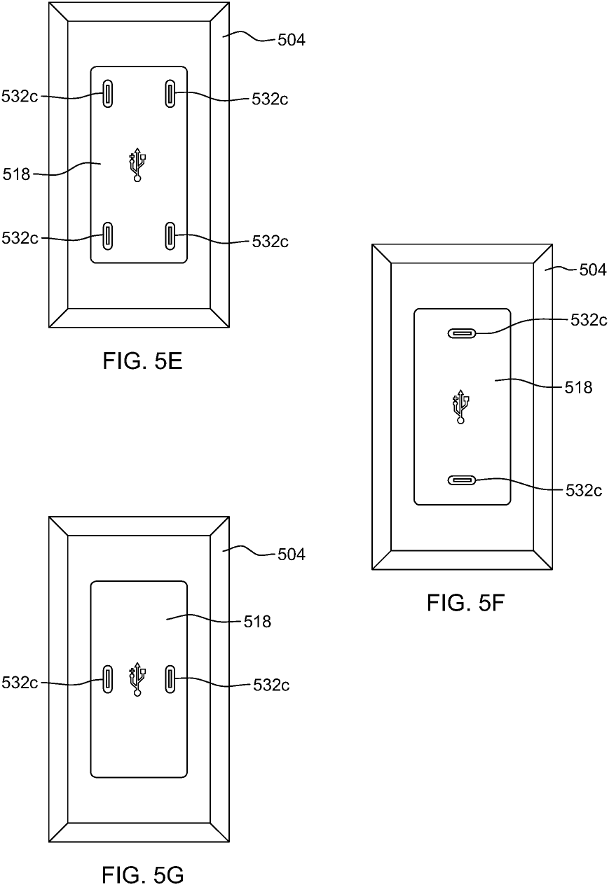

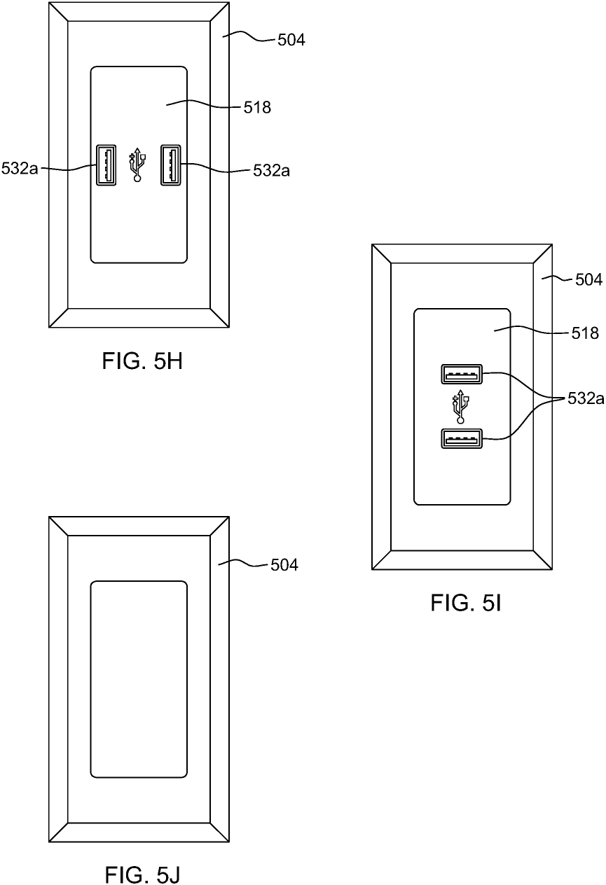

FIGS. 5A-5J depict example embodiments of configurations for front faces of wiring devices, in accordance with aspects described herein. FIGS. 5A-5C depict examples that include both 120 V line voltage receptacles and USB connectors. FIGS. 5D-5I depict examples that include only USB connectors, and FIG. 5J depicts an example with no USB or line voltage receptacles, and only a blank front face of the wiring device or wall plate 504.

FIGS. 5A-5C depict wall plates 504 with apertures exposing front faces 518 of the housings of the respective wiring devices. The wiring devices each include two line voltage receptacles/connectors 530. The line voltage receptacles can be configured to couple a source of AC power to an electrical plug inserted therein. Between the line voltage receptacles 530 in each example are USB connectors/ports. Specifically, FIG. 5A includes two vertically-oriented USB-C ports 532c, FIG. 5B includes a vertically-oriented USB-A port 532a and vertically-oriented USB-C port 532c, and FIG. 5C includes two vertically-oriented USB-A ports 532a. In these examples, the wiring devices can include one or more induction coil(s) (not shown) situated where desired, for instance in spaces between line voltage receptacle(s) 530 and/or USB connector(s) 532. In other examples, the wiring device includes just one line voltage receptacle 530 and induction coil(s) positioned above or below the single line voltage receptacle 530.

FIGS. 5D-5I each show examples that include a wall plate 504 and front face 518 having two or more USB connectors of type USB-A (532a) or USB-C (532c).

Orientations of the USB connectors can be horizontal or vertical, as shown, or any other desired orientation. Furthermore, the positioning and orientation of the USB connectors and/or line voltage receptacles can vary as desired from the specific examples of FIGS. 5A-5I. In these examples, the wiring devices can include one or more induction coil(s) (not shown) situated where desired, for instance in spaces between the USB connector(s).

In accordance with yet other embodiments, a wiring device is a multi-gang device, i.e. having a multi-gang housing, and is configured to couple to a multi-gang electrical box. The device can include one or more induction coils in addition to one or more line voltage receptacle(s) and/or USB connector(s), for example. In such a wiring device having a multi-gang housing, the multi-gang housing can include a first region, within which an induction coil is at least partially disposed, and one or more second region(s) within which line voltage receptacle(s) are at least partially disposed.

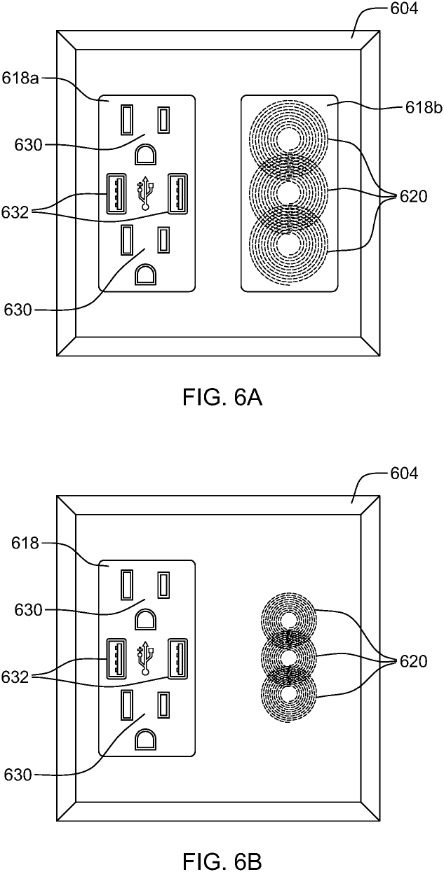

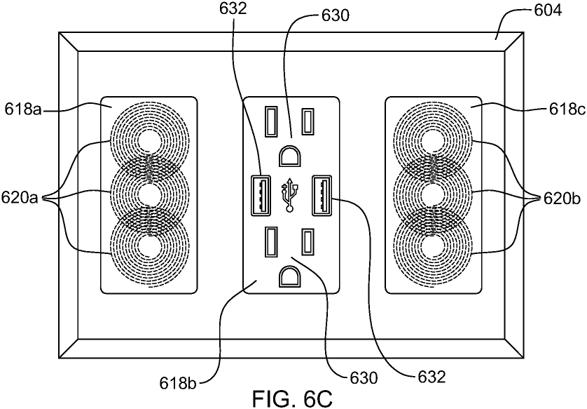

FIGS. 6A-6C depict example embodiments of wiring devices with multi-gang housings, configured for coupling to multi-gang electrical wall boxes, in accordance with aspects described herein. FIGS. 6A and 6B depict respective dual-gang wiring devices partially covered with a wall plate 604. In FIG. 6A, wall plate 604 covers the wiring device leaving two front faces 618a, 618b exposed, each in a respective gang position. The housing can have multiple regions corresponding to the different gang positions (two in this example). The wiring device includes two line voltage receptacles 630 and two USB-A connectors 632 in one region of the housing corresponding to the left gang position, and three induction coils 620 in another region of the housing corresponding to the right gang position. The induction coil(s) are disposed on one side of the line voltage receptacles 630 in this configuration.

FIG. 6B is similar to FIG. 6A in that the wiring device has a dual-gang housing with two line voltage receptacles 630 and two USB ports 632 in one region thereof corresponding to the left gang position and exposed on front face 618, and three induction coils 620 in another region of the wiring device region corresponding to the right gang position. However, in FIG. 6B there is no second front face of the wiring device housing exposed via an aperture of wall plate 604. Here, the wall plate 604 is ‘blank’ in the right gang position.

FIG. 6C depicts an example three-gang wiring device. The device is covered by wall plate 604 having thee apertures through which front faces 618a, 618b, 618c in gang positions left, center, and right, respectively, as accessible. One region of the wiring device housing at the center gang position includes two line voltage receptacles 630 and two USB-A connectors 632. Another region at the left gang position includes a set of three induction coils 620a while yet another region at the right gang position includes a set of three induction coils 620b. The induction coils can be part of separate charging circuits at least partially disposed within the housing of the wiring device, with each separate charging circuit driving a respective set of coils, or a common charging circuit that drives both sets of coils. The device of FIG. 6C can simultaneously wirelessly charge electronic devices in the left and the right gang positions proximate the respective regions of the wiring device.

As noted, any of the foregoing wiring devices and wall plates may be sold separate or together, i.e. as part of a kit. In a particular embodiment, the kit includes a wiring device and a wall plate configured to cover at least a portion of the wiring deice. The wiring device can include a housing having a front face, and a strap, the strap being coupled to the housing, and the strap being configured to couple the wiring device to an electrical box. The wiring device can further include a line input terminal configured to couple to a source of alternating current (AC) power, and a charging circuit disposed at least partially within the housing and coupled to the line input terminal. The charging circuit can include one (or more) induction coil(s) configured to propagate a magnetic charging field to emanate from the wiring device. The wall plate can include one (or more) magnet(s). A magnet can be configured to magnetically attract an electronic device when the electronic device is proximate the front face of the housing of the wiring device. Additionally or alternatively, the electrical device could include magnet(s), for instance one or more magnet(s) disposed proximate the front face.

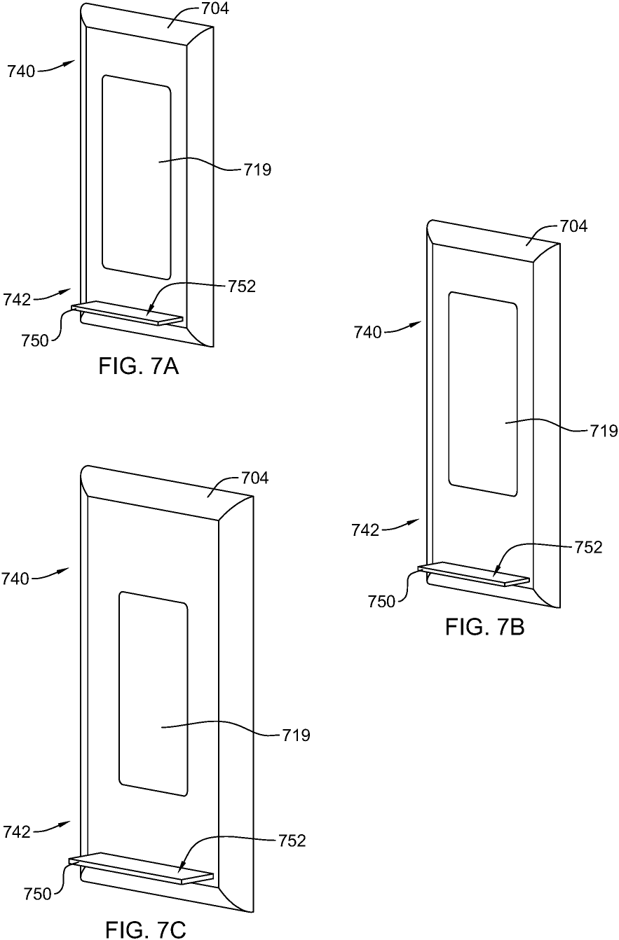

In yet further embodiments, wall plates are provided that include a shelf. FIGS. 7A-7C depict example embodiments of wall plates that include a shelf, in accordance with aspects described herein. FIGS. 7A, 7B, and 7C are identical except their sizing, with FIG. 7A being ‘standard’ size, FIG. 7B being ‘extended’ size, and FIG. 7C being ‘oversized’ size. Each wall plate 704 has a top portion 740 and bottom portion 742 defined by their position above and below, respectively, aperture 719 of the wall plate 704. Each wall plate 704 includes a shelf 750 protruding from the bottom portion 742 of the wall plate. The shelf 750 may be configured to support an electronic device, for instance in position of a front face of a housing of a wiring device with which the wall plate is used. The shelf 750 has a top surface 752 on which the electronic device can rest to position the device in a charging region and facilitate charging the electronic device. In this manner, this shelf can be used to hold and support the target device while charging.

A shelf may be useful in situations where the weight, material, phone case, or other factors render the magnets (if present) of the wiring device and/or wall plate unable to hold the target device in place. The magnetic attraction between the target electronic device and the magnet(s) of the wiring device/wall plate may not be strong enough to support the weight of the electronic device and maintain it in a desired position for wireless charging. The target device could fall from the wireless charging device if knocked or disturbed, for example. A shelf can address this problem of gravity pulling the device away from the charging region.

While the target device could potentially become disconnected from the charging device by falling over the front of the shelf, or to the sides of the shelf, in some examples magnet(s) built into the wiring device and/or wall plate could pull (magnetically attract) the target device toward the wiring device. In this regard, magnet(s) in the wall plate and/or wiring device itself can be disposed and configured to attract a top portion of the electronic device toward the wiring device/front face thereof while the shelf supports the electronic device. This magnetic pull could reduce the likelihood of the target device falling off of the shelf, while helping to keep the electronic device within the wireless charging region of the wiring device, the charging region defined by the magnetic charging field.

Though in these embodiments the shelf protrudes from a portion of the wall plate, in other embodiments the wiring device includes a shelf, for instance a shelf that protrudes from a front face of the wiring device housing to perform the weight-bearing function described above.

A shelf could be provided as a component of any wiring device or wall plate described herein. A wall plate that incorporates a shelf for supporting an electronic device could include magnets arrayed across the top portion of the wall plate (and optionally in some embodiments the bottom portion of the wall plate).

The shelf 750 could be integral with rest of the wall plate body or as a separate component that is coupled (screwed, fastened, adhered, stuck, or the like) to the wall plate body.

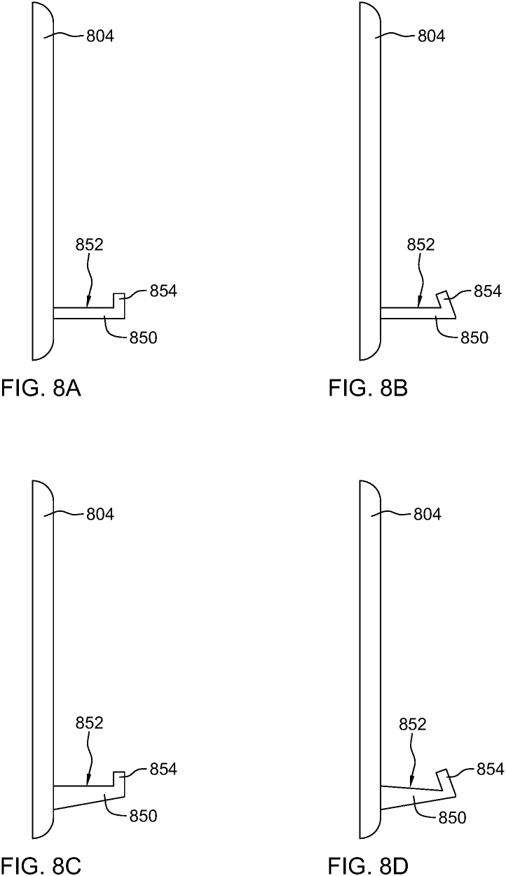

FIGS. 8A-8D depict additional example embodiments of wall plates that include a shelf, in accordance with aspects described herein. Shown are side views of wall plates 804, each including a respective shelf 850 having a lip 854 protruding from a top surface 852 of the shelf. FIGS. 8A and 8B differ from each other in that the lip 854 of FIG. 8A protrudes perpendicularly from the top surface 852 of shelf 850, while the lip 854 of FIG. 8B protrudes from the top surface 852 angled toward the wall plate 804. FIGS. 8C and 8D correspond to FIGS. 8A and 8B, respectively, except that the shelf is thickest at the base (near the wall plate 804) and thins moving from the base of the shelf away from the wall plate 804 to the lip 854.

The shelf could be made of or include any desired material. In some embodiments, the shelf and/or top surface is made of a no-slip or anti-slip material, such as a no-slip rubber, designed to prevent the electrical device from sliding on the top surface of the shelf.

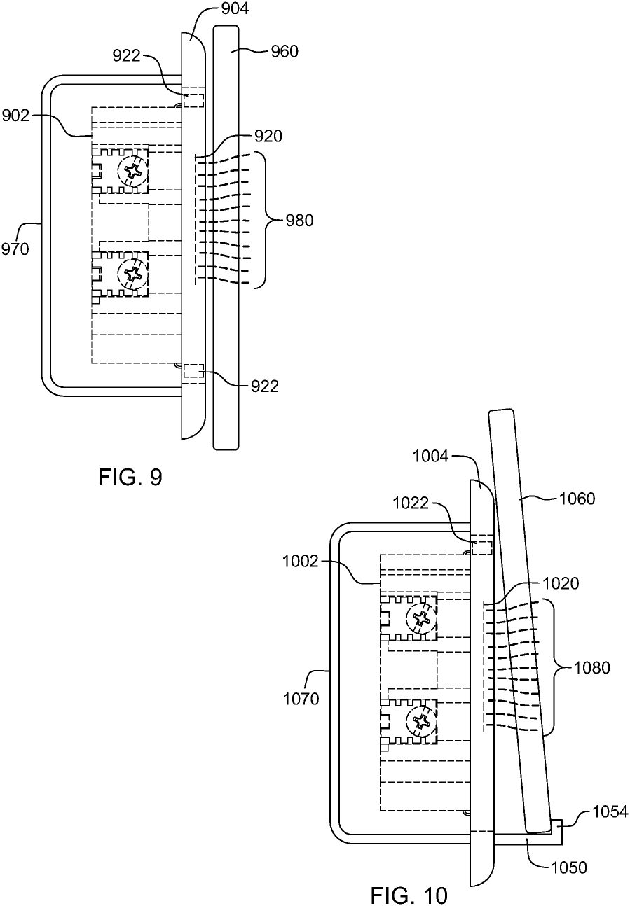

FIGS. 9 and 10 depict side views of example embodiments of an electronic device in operative position via magnetic attraction for wireless charging using a wiring device, in accordance with aspects described herein. Referring to FIG. 9, wiring device 902 is mounted in wall box 970 and covered with wall plate 904. Disposed proximate a front face of the wiring device housing is an inductive charging coil 920 that propagates a magnetic charging field 980 that emanates from the wiring device 902 and defines charging region. Magnets 922 are situated above and below coil 920 proximate the front face. The magnets 922 magnetically attract electronic device 960 to retain the device 960, and more particularly an inductive charging coil (not pictured) of the device 960, in the charging region defined by the magnetic charging field 980.

FIG. 10 is similar to FIG. 9 and includes wiring device 1002, wall box 1070, wall plate 1004, inductive charging coil 1020, magnet(s) 1022, electrical device 1060, and magnetic charging field 1080. FIG. 10 differs from FIG. 9 in that wall plate 1004 includes shelf 1050 having lip 1054 and includes only magnet(s) 1022 at a top portion of the front face of the wiring device. The electronic device 1060 is positioned on shelf 1050. Magnetic attraction between the magnet(s) 1022 and electronic device 1060 pulls the top of the device 1060 toward the wiring device 1002 and closer to the induction coil 1020 to facilitate better wireless charging efficiency. The magnet(s) 1022 can be disposed and configured to attract a top portion of the electronic device 1060 toward the wiring device as the shelf 1050 supports the electronic device 1060. This feature could be useful not only for retaining the device 1060 in charging position but also in cases of poor initial placement of the electronic phone 1060 on the shelf 1050. For example, the magnet(s) 1022 can automatically pull/shift the electronic device 1060 or portion (e.g. top) thereof into a correct position closer to the charging electronics.

Although various embodiments are described above, these are only examples. For example, computing environments of other architectures can be used to incorporate and use one or more embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A wiring device comprising:
a housing comprising a front face;
a strap, the strap being coupled to the housing, the strap being configured to couple the wiring device to an electrical box;
a line input terminal configured to couple to a source of alternating current (AC) power;
a charging circuit at least partially disposed within the housing, the charging circuit coupled to the line input terminal, the charging circuit comprising an induction coil configured to propagate a magnetic charging field to emanate from the wiring device; and
a magnet disposed proximate the front face of the housing of the wiring device and configured to magnetically attract an electronic device when the electronic device is proximate the front face of the housing of the wiring device.

2. The wiring device of claim 1, wherein the magnet comprises an electromagnet coupled to the line input terminal and powered thereby.

3. The wiring device of claim 1, wherein the wiring device comprises a plurality of magnets disposed proximate the front face of the housing of the wiring device.

4. (canceled)

5. The wiring device of claim 3, wherein the plurality of magnets is disposed at least partially peripheral to the induction coil.

6. (canceled)

7. The wiring device of claim 1, wherein the magnet is disposed in a center of the induction coil.

8. The wiring device of claim 1, wherein the charging circuit comprises a plurality of induction coils, wherein each inductive coil is configured to propagate a magnetic charging field.

9. The wiring device of claim 1, further comprising:
a Universal Serial Bus (USB) connector; and
a USB charging circuit coupled to the line input terminal and the USB connector.

10. The wiring device of claim 1, further comprising a line voltage receptacle configured to selectively couple the source of AC power to an electrical plug.

11. The wiring device of claim 10, wherein the housing is a multi-gang housing, wherein the multi -gang housing further comprises a first region and a second region, wherein the induction coil is disposed at least partially within the first region of the multi-gang housing and the line voltage receptacle is disposed at least partially within the second region of the multi-gang housing.

12-13. (canceled)

14. A kit comprising:
a wiring device, the wiring device comprising:
a housing comprising a front face;
a strap, the strap being coupled to the housing, the strap being configured to couple the wiring device to an electrical box;
a line input terminal configured to couple to a source of alternating current (AC) power; and
a charging circuit at least partially disposed within the housing, the charging circuit coupled to the line input terminal, the charging circuit comprising an induction coil configured to propagate a magnetic charging field to emanate from the wiring device; and
a wall plate configured to cover at least a portion of the wiring device, the wall plate comprising:
a magnet configured to magnetically attract an electronic device when the electronic device is proximate the front face of the housing of the wiring device.

15. The kit of claim 14, wherein the wall plate comprises a plurality of magnets arrayed across a top portion and a bottom portion of the wall plate.

16. The kit of claim 14, wherein the magnet is an elongated magnet disposed proximate one side of the wall plate.

17. The kit of claim 14, wherein the wall plate comprises a plurality of elongated magnets each disposed proximate a respective side of a plurality of sides of the wall plate.

18. (canceled)

19. The kit of claim 14, wherein the wiring device comprises a magnet disposed proximate the front face of the housing of the wiring device.

20-23. (canceled)

24. The kit of claim 14, wherein the wall plate comprises a surface and is configured to cover the front face of the housing of the wiring device, and wherein the magnetic charging field is configured to emanate from the wiring device through the surface of the wall plate.

25. The kit of claim 14, wherein the wall plate comprises an aperture through which the front face of the housing of the wiring device is accessible, wherein the wall plate is configured to at least partially surround the front face of the housing of the wiring device when the wiring device is mounted in the electrical box.

26. A wall plate configured for at least partially covering a wiring device, the wall plate comprising:
a top portion and a bottom portion;
a shelf protruding from the bottom portion of the wall plate and configured to support an electronic device in position of a front face of a housing of the wiring device; and
a magnet configured to magnetically attract the electronic device when the electronic device is proximate the front face of the housing of the wiring device.

27. The wall plate of claim 26, wherein the wall plate comprises a plurality of magnets arrayed across the top portion of the wall plate.

28. The wall plate of claim 26, wherein the magnet comprises an elongated magnet disposed proximate one side of the wall plate.

29. The wall plate of claim 26, wherein the wall plate comprises a plurality of elongated magnets each disposed proximate a respective side of a plurality of sides of the wall plate.

30. The wall plate of claim 26, wherein the magnet is disposed and configured to attract a top portion of the electronic device toward the wiring device as the shelf supports the electronic device.

31. (canceled)
